(19) United States
(12) Patent Application Publication
(10) Pub. No.: US 2016/0310957 A1
(43) Pub. Date: Oct. 27, 2016

(54) METHOD FOR THE FRACTIONATION OF AN OILSEED CAKE, AND APPLICATIONS OF SAID METHOD

(71) Applicant: INSTITUT NATIONAL DE LA RECHERCHE AGRONOMIQUE, Paris Cedex 07 (FR)

(72) Inventors: ABDELLATIF BARAKAT, MONTPELLIER (FR); XAVIER ROUAU, MONTPELLIER (FR)

(21) Appl. No.: 15/103,843

(22) PCT Filed: Dec. 24, 2014
(86) PCT No.: PCT/EP2014/079320

§ 371 Date: Jun. 10, 2016

(30) Foreign Application Priority Data
Dec. 24, 2013 (FR) 1 363 534

(51) Int. Cl. B02C 23/08; B03C 7/00; C10L 1/02

(52) U.S. Cl. CPC B02C 23/08; C10L 1/02; B03C 7/006; C10L 2200/0484; C10L 2290/28; C10L 2290/38; C10L 2290/54

(57) ABSTRACT

A dry method for the fractionation of oilseed cakes. Oilseed cakes are grounded into a powder of ultrafine particles. The ultrafine particles of the powder are triboelectrostatically charged. The path of the charged particles in the electric field is deviated to sort the particles and to provide at least one lignocellulose-enriched fraction.

### TECHNICAL FIELD OF THE INVENTION

The present invention relates to a process for the fractionation of an oilseed cake and to applications of this process. It applies in particular to the extraction of lignocellulose and proteins from a cake, to the production of biomolecules and biopolymers of interest and to the production of biofuel or biogas.

### PRIOR ART

The term “oilseed cakes” refers to the solid residues obtained after the extraction of the oil from seeds or fruits of oleaginous plants, such as sunflower, rapeseed or soya, for example.

Oilseed cakes form a material that is not highly exploited, generally used for animal feed, once the oil has been extracted from the seed or the fruit of the oleaginous plant. However, these cakes are rich in constituents of industrial interest, such as proteins and lignocellulose (also called “fiber”), the applications of which in “biorefineries” lead to the production of bioenergy, of biomolecules and of biomaterials. The principal difficulty for this type of exploitation lies in the separation of the fibers and proteins contained in the cakes without modifying their structures and their functional properties.

A known document is U.S. Pat. No. 3,271,160, which relates to the exploitation of oilseed cakes by separation of particles according to their sizes.

In current systems, as described in European patent EP 1 908 355, the oilseed cakes are ground in a first step. These particles rich in proteins or in fibers resulting from the grinding are then separated by sorting in a corona discharge electric field. However, the efficiency of this sorting in an electric field is low and, consequently, the separation of the protein-rich fractions and fiber-rich fractions is not satisfactory. In addition, the speed of separation is very low. Furthermore, these systems operate with particles of which the size is between 250 micrometers and 1400 micrometers and do not therefore enable sorting of finer particles. However, the finer the particles, the more homogeneous is their composition, and their content either protein or in fiber, is likely to be high. Furthermore, the particles resulting from grinding of oilseed cakes are not very subject to electrical attraction.

In another prior art system, described in European patent EP 1 441 858, the sorting of particles resulting from the grinding of wheat bran in an electric field makes it possible to separate particles corresponding respectively to the aleurone and to the shells of the cereal seeds. However, these systems do not operate in the case of fine particles. Furthermore, these particles, even fine, are, after grinding, not very naturally subject to electrical attraction.

### SUBJECT OF THE INVENTION

The present invention aims to remedy all or some of these drawbacks.

To this effect, according to a first aspect, the present invention relates to a dry process for the fractionation of oilseed cakes, which comprises:
a step of grinding oilseed cakes into a powder of ultrafine particles,
a step of triboelectrostatically charging ultrafine particles of said powder, and
at least one step of deviating the path of the charged particles in the electric field in order to sort the particles and to provide at least one lignocellulose-enriched fraction.

The term “ultrafine particles” is intended to mean a set of particles of which the median diameter (d50) is less than 500 μm. The homogeneity of the particles resulting from the grinding of oilseed cakes increases when their size decreases. Indeed, some particles are mainly composed of lignin present in the walls of the oleaginous plants and others are mainly composed of proteins from the cells of the oleaginous plants. The triboelectrostatically charging step allows the particles to charge with or discharge electrons according to their principal chemical component. The deviating step thus separates the particles of which the principal components are different. The process which is the subject of the invention thus makes it possible to collect the lignocellulose-enriched cake fractions. It is observed that the lignocellulose thus obtained is in the native state, i.e. it is not modified or denatured, contrary to the prior art processes, such as the Organosolv (registered trademark) process for lignin extraction (see “Quantitative structural characterization and thermal properties of birch lignins after auto-catalyzed organosolv pretreatment and enzymatic hydrolysis” Jia-Long Wen et al., September 2013 in the Journal of Chemical Technology and Biotechnology Volume 88, Issue 9, pages 1663-1671), which comprises a denaturation by chemical treatment.

In advantageous embodiments, a grinding means, a receiving means, a charging means and each deviating means are assembled in a single device implementing the process which is the subject of the present invention. Thus, the device is more compact. In addition, the powder does not have the time to aggregate, to take up moisture, to oxidize or, more generally, to change state, between the grinding and the deviating. The implementation of the process which is the subject of the present invention is thereby improved.

In embodiments, the grinding step comprises a step of configuring the grinder so as to obtain a predetermined fineness. These embodiments allow a user to adjust the fineness of the grinding according to the cakes ground and to the desired sorting quality.

In embodiments, the process which is the subject of the present invention also comprises a step of scraping an electrode of an electrostatic sorting means used during the deviating step, so as to collect the particles attached to an electrode after the particle deviating step.

These embodiments make it possible to collect the particles attached to the electrode, the electric charge of which is strong, which means that the make-up thereof is particularly homogeneous.

In embodiments, the process which is the subject of the present invention also comprises a step of cyclically reversing the polarity of each electrode of an electrostatic sorting means used during the deviating step.

These embodiments make it possible to detach the particles attached to the electrodes, the make-ups of which are particularly homogeneous, and to collect the particles attached to each electrode without mechanical action such as scraping.

In embodiments, the process which is the subject of the present invention comprises, downstream of the deviating step, at least one secondary deviating step.

The separation of the components resulting from the plurality of successive sorting operations carried out by the process is then more precise.

In embodiments, during a secondary deviating step, a triboelectrostatically charging means is fed with particles which, during the deviating steps, are alternately deviated toward a positive electrode and a negative electrode or vice versa.

The advantage of these embodiments is that they allow the particles which, during two successive sorting operations (first and second stage), have been deviated once toward the positive electrode and once toward the negative electrode, to follow a new implementation of the process which is the subject of the present invention.

In embodiments, the process which is the subject of the present invention also comprises, downstream of at least one deviating step, a step of enzymatically purifying the sorted particles.

An enzymatic purification and/or extraction (cellulase and hemicellulases) is thus carried out in order to further enrich the fractions with proteins and with polyphenols (lignin and phenolic acids) by degradation or hydrolysis of the polysaccharides into monosaccharides (glucose, xylose, arabinose, etc.).

In embodiments, the process which is the subject of the present invention comprises, downstream of at least one deviating step, a step of comparing the sizes of particles with a predetermined limit value and a step of feeding a grinding means with particles of which the sizes are greater than the predetermined limit.

By virtue of these arrangements, the particles which are too large to be efficiently sorted are ground again so as to optimize the sorting thereof. On the other hand, the particles of which the sizes are nominal can be sorted again without undergoing supplementary grinding.

In embodiments, during the charging step, a dynamic fluidized air bed is used.

The use of a fluidized air bed makes it possible both to form the electrostatic charges on the moving particles and to separate them with a view to sorting them.

According to a second aspect, the present invention relates to a use of the process which is the subject of the present invention for obtaining ignocellulose-enriched fractions.

According to a third aspect, the present invention relates to a use of the process which is the subject of the present invention for obtaining protein-enriched fractions.

According to a fourth embodiment, the present invention relates to a use of the process which is the subject of the present invention for generating biofuel from lignocellulose-enriched fractions.

This biofuel comprises, for example, biohydrogen and/or bioethanol.

According to a fifth aspect, the present invention relates to a use of the process which is the subject of the present invention for generating biogas from lignocellulose-enriched fractions.

According to a sixth aspect, the present invention relates to a use of the process which is the subject of the present invention for obtaining polysaccharide-enriched fractions.

According to a seventh aspect, the present invention relates to a use of the process which is the subject of the present invention for extracting and obtaining phenolic-derivative-enriched fractions.

The phenolic derivatives comprise, in particular, tannins and phenolic acids.

Since the advantages, objectives and particular characteristics of the uses which are subjects of the present invention are similar to those of the process which is the subject of the present invention, they are not summarized herein.

### BRIEF DESCRIPTION OF THE FIGURES

Other advantages, objectives and particular characteristics of the invention will emerge from the nonlimiting description which follows of at least one particular embodiment of the fractionation device and process which are subjects of the present invention, with regard to the appended drawings, in which:

FIG. 1 represents, diagrammatically and in section, a first particular embodiment of the device which is the subject of the present invention,

FIG. 2 represents, diagrammatically and in section, a second particular embodiment of the device which is the subject of the present invention,

FIG. 3 represents, diagrammatically and in section, a part of one of the embodiments illustrated in FIGS. 1 and 2,

FIG. 4 represents, in the form of a flow diagram, steps of a particular embodiment of the process which is the subject of the present invention,

FIG. 5 represents, in the form of a histogram, the distribution of the phenolic acids obtained by carrying out the process which is the subject of the present invention with a sunflower cake,

FIG. 6 represents, diagrammatically, an enzymatic purification and/or extraction to further enrich the fractions with proteins and with polyphenols, and

FIG. 7 represents an experimental example of sugar yield after enzymatic hydrolysis.

### DESCRIPTION OF IMPLEMENTATION EXAMPLES OF THE INVENTION

The present description is given in a nonlimiting manner.

It is immediately noted that the figures are not to scale.

The term “ultrafine” refers to a powder of which the particles have a median diameter of less than 500 micrometers, preferentially of between 10 micrometers and 500 micrometers, more preferentially of between 30 micrometers and 500 micrometers, and even more preferentially of between 50 micrometers and 500 micrometers.

According to another definition, the term “ultrafine” refers to a powder of which half (50%) by volume of the fibers have a diameter of less than 500 micrometers, preferentially less than 200 micrometers, more preferentially less than 100 micrometers and even more preferentially less than 50 micrometers.

A laser particle size analyzer can be used to measure the particles.

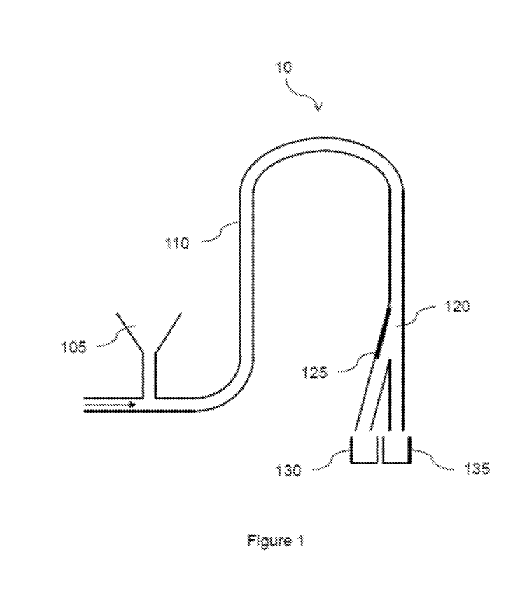

A first embodiment of the device 10 which is the subject of the present invention is observed in FIG. 1. This device 10 comprises:

an inlet 105 for ultrafine particles resulting from a grinding of oilseed cakes,

a means 110 for triboelectrostatically charging the particles received, and

a principal electrostatic sorting means 120 for sorting the particles transmitted.

The inlet 105 for ultrafine particles is, for example, a hopper or a funnel configured so as to make it possible to pour in a powder of ultrafine particles resulting from the grinding of oilseed cakes.

The particles thus poured into the particle inlet 105 pass through a charging means 110 placed, for example, under the particle inlet 105. This charging means 110 is configured so that the particles pass through this charging means 110 by virtue of gravitational force. In variants, the movement of the particles is ensured by a fluidized air bed system, i.e. a system that is ventilated by virtue of a turbine or a fan. The triboelectrostatic charging is carried out by collision between the particles and the internal surface of a pipe. This surface comprises at least one part made of polyvinyl chloride (abbreviated as “PVC”). In variants, this surface comprises at least one part made of teflon. In other variants, this surface comprises at least one part made of glass. In other variants, this surface comprises at least one part made of steel. PVC, teflon, glass and steel have optimal properties for charging particles rich in proteins or in lignocellulose. The charging means 110 is connected to the inlet of the sorting means 120.

The principal electrostatic sorting means 120 for sorting the particles transmitted comprises at least one electrode 125. This sorting means 120 is configured for sorting the transmitted particles into lignocellulose-enriched fractions. This sorting is carried out using the positively or negatively polarized electrode 125. Thus, the charged particles are attracted or repelled by the electrode 125. At the outlet of this principal electrostatic sorting means 120, two pipes allow the particles to pour into two containers 130 and 135. The particles which have been attracted or repelled by the electrode 125 according to the polarization of the electrode 125 are poured into a first container 130. The other particles are poured into the second container 135.

In particular, the lignocellulose-enriched particles are charged with positive charges in the charging means 110. Consequently, these lignocellulose-enriched particles are attracted by a negatively polarized electrode. Thus, the particles pour into the pipe and then into the container 130 in proximity to the negatively charged electrode comprising lignocellulose-enriched fractions.

The ultrafine particles resulting from the grinding of oilseed cakes have the advantage of having a very homogeneous chemical composition. The triboelectrostatically charging means 110 allows the particles to charge with or discharge electrons according to their principal chemical component. The principal electrostatic sorting means 120 thus separates the particles of which the principal components are different. The device 10 thus separates the lignocellulose-enriched cakes fractions.

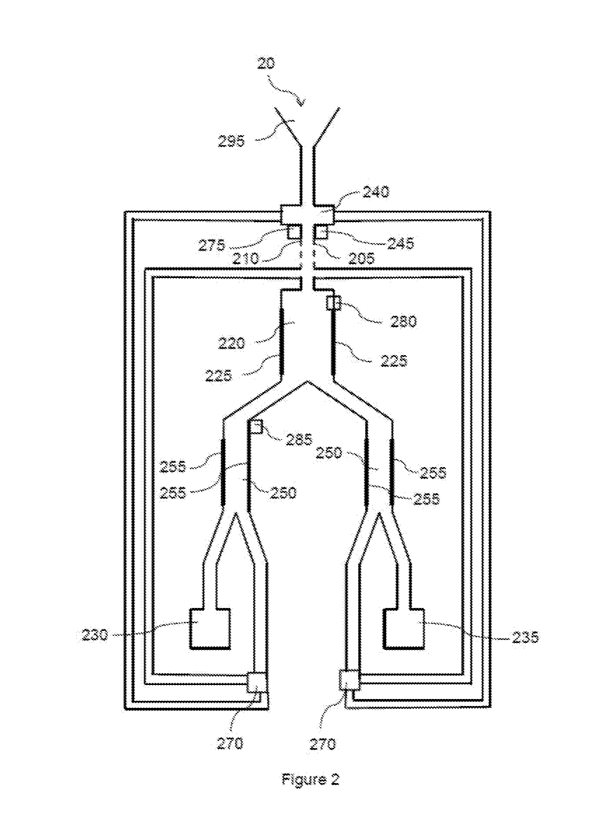

A second particular embodiment of the device 20 which is the subject of the present invention is observed in FIG. 2. This device comprises:
a means 240 for grinding cakes into a powder of ultrafine particles, comprising:
   a means 245 for configuring the fineness of grinding carried out by the grinding means 240, and
   a means 275 for configuring the temperature of the grinding means 240;
an inlet 205 for ultrafine particles resulting from a grinding of oilseed cakes,
a means 210 for triboelectrostatically charging the particles received,
a principal electrostatic sorting means 220 for sorting the particles transmitted, which comprise:
   two electrodes 225;
   a means 280 for scraping an electrode of the principal electrostatic sorting means 220, and
   a means 285 for reversing the polarity of an electrode 225 of the principal electrostatic sorting means 220;
two secondary electrostatic sorting means 250, each comprising two electrodes 255, and
two means 270 for comparing the particle sizes in comparison to a predetermined limit value.

The means 240 for grinding the cakes into a powder of ultrafine particles is, for example, a centrifugal grinder configured for grinding the cakes into particles of which the diameter is between 50 micrometers and 500 micrometers. This grinding means 240 comprises a means 245 for configuring the fineness of the grinding carried out by the grinding means 240. This means 245 for configuring the fineness of the grinding is, for example, a touch screen on which a computer program displays the current grinding fineness, an interactive zone allowing a user to increase the grinding fineness and an interactive zone which allows the user to reduce the grinding fineness. Depending on the grinding fineness configured, the grinding means 240 is configured for grinding the cakes into a powder of particles of which the diameter has been defined by the configuring means 245. This grinding means 240 also comprises a means 275 for configuring the temperature of the grinding means 240. This temperature configuring means 275 is, for example, a touch screen on which a computer program displays the current temperature of the grinding means 240, an interactive zone which allows a user to increase said temperature and an interactive zone which allows the user to reduce said temperature.

The inlet 205 for ultrafine particles resulting from a grinding of oilseed cakes is, for example, a pipe connecting the grinding means 240 and the means 210 for triboelectrostatically charging the particles received.

The means 210 for triboelectrostatically charging the particles received is, for example, an internal surface of a pipe of which at least one part is made of glass, teflon, PVC or steel. The particles running through the pipe become charged on contact with the charging means 210. In particular, the lignocellulose becomes charged with positive charges and the proteins become charged with negative charges.

The particles move in the charging means 210 by virtue of the use of a dynamic fluidized air bed made to move by a turbine, for example.

The principal electrostatic sorting means 220 for sorting the particles transmitted is, for example, a cylindrical pipe on the internal surface of which are placed two diametrically opposed electrodes 225. One of these electrodes 225 is positively polarized, and the other electrode 225 is negatively polarized. In proximity to each of these electrodes 225 and downstream of the sorting means 220 are positioned two pipes configured so as to allow the particles being attracted by one or other of the electrodes 225 to pass through. The particles negatively charged by the charging means 210 are attracted by the positively charged electrode 225. The particles positively charged by the charging means 210 are attracted by the negatively charged electrode 225.

This principal electrostatic sorting means 220 comprises, in addition, a means 280 for scraping an electrode of the principal electrostatic sorting means 220. This scraping means 280 is, for example, a shape made of flexible plastic configured to conform to the shapes of the electrode 225 on which the shape is placed. This shape is moved by a mechanical motor when the device is stopped.

This scraping means 280 is configured for collecting the particles thus scraped. The scraped particles have the particularity of comprising a large number of fractions attracted by the electrode 225, to the extent that these particles have attached to the electrode 225. For example, in the case of a negatively charged electrode 225, the particles collected by the scraping means 280 comprise predominantly fractions comprising lignocellulose.

This principal electrostatic sorting means 220 comprises, in addition, a means 285 for reversing the polarity of an electrode 225 of the principal electrostatic sorting means 220. This polarity reversing means is, for example, an electronic circuit, operated for one tenth of a second every minute, configured for reversing the polarity of the electrode 225. The reversing of polarity makes it possible to harvest the particles attached to said electrode 225.

In variants, the principal electrostatic sorting means 220 comprises a scraping means 280 and a polarity reversing means 285 for each electrode 225 for the sorting means 220.

A secondary electrostatic sorting means 250 is placed at the end of each of the pipes of the principal electrostatic sorting means 220. Each of these secondary electrostatic sorting means 250 comprises a positively or negatively polarized electrode. The electrode of the secondary sorting means 250 is polarized in a similar manner to the electrode in proximity to the pipe to which said secondary sorting means 250 is attached.

In variants, the electrode of the secondary sorting means 250 is polarized in reverse manner to the electrode in proximity to the pipe to which said secondary sorting means 250 is attached.

In variants, at least one secondary electrostatic sorting means 250 comprises two oppositely polarized electrodes located on either side of said secondary sorting means 250. In this way, the particles comprising a majority of fractions comprising lignocellulose are attracted by one of the electrodes, while the particles comprising a majority of fractions comprising proteins are attracted by the other electrode.

Each secondary electrostatic sorting means 250 thus makes it possible to sort, on the one hand, the particles comprising a majority of lignocellulose and, on the other hand, the particles comprising a majority of proteins.

Two pipes are placed at the outlet of each secondary sorting means 250. A first pipe corresponds to a result from similar sorting, termed “convergent”, by the first sorting means 220 and the secondary sorting means 250 at the outlet of which this pipe is placed. For example, a particle comprising a considerable proportion of lignocellulose is positively charged, then attracted by the negatively charged electrode in the sorting means 220, then finally attracted by the negatively charged electrode in the secondary sorting means 250. In the case where the result of the sorting of a particle by the sorting means 220 and the secondary sorting means 250 is different, it is said that the result of the sorting “diverges”. In the case where the result of the sorting by the sorting means 220 and the secondary sorting means 250 diverges, the particle enters the second pipe at the outlet of said secondary sorting means 250.

In variants, at least one secondary sorting means 250 comprises at least one scraping means 280 and/or one polarity reversing means 285 which are similar to those configured for the principal electrostatic sorting means 220.

Each pipe configured for receiving the particles for which the result of the sorting by the sorting means 220 and the secondary sorting means 250 diverges comprises a means 270 for comparing the particle sizes in comparison with a predetermined limit value. This comparing means 270 is, for example, a sorter of cyclone type. In variants, this comparing means 270 is a filter configured for retaining the particles of which the sizes are greater than the predetermined limit value.

The particles of which the sizes are greater than the predetermined limit value are transmitted to the grinding means 240 so as to be ground again.

The particles of which the sizes are less than the predetermined limiting value are transmitted again to the charging means 210 in order to be sorted.

The ultrafine particles resulting from the grinding of oilseed cakes have the advantage of having a very homogeneous chemical composition. The triboelectrostatically charging means 210 allows the particles to charge with or discharge electrons according to their principal component. The principal electrostatic sorting means 220 thus separates the particles of which the principal components are different. The device 20 thus separates the lignocellulose-enriched cakes fractions from the protein-enriched fractions, these two components having different properties and different industrial applications.

Furthermore, the separation of the components resulting from the plurality of successive sorting operations carried out by the principal sorting means 220 and the two secondary sorting means 250 of the device 20 is then more precise than if the device 20 comprised a single principal electrostatic sorting means 220, as in the device 10 illustrated in FIG. 1.

The device 20 gathers the grinding means 240, the receiving means 205, the charging means 210 and each sorting means 220, 250. Thus, the device 20 is more compact. Furthermore, the powder does not have the time to aggregate, to take up moisture, to oxidize, or, more generally, to change state, between the grinding and the sorting. The operating of the device is thereby improved.

The mean diameter of the particles at the outlet of the grinding means 240 of the device 20 makes it possible to obtain particles which:
have a homogeneous chemical composition and
once charged, remain mobile according to their charge in the presence of the electrodes.

By virtue of the comparing means 270 of the device 20, the particles which are too large to be efficiently sorted are ground again so as to optimize the sorting of these particles. On the other hand, the particles of which the sizes are nominal can be re-sorted without further grinding.

The temperature configuring means 275 of the grinding means 240, configured so that the cake reaches a temperature at which at least one oilseed cake component becomes brittle, allows the grinding means 240 to more readily grind the cakes into oilseed cake particles. It is noted that cryogenics has the advantage of protecting the proteins and vitamins.

The use of a fluidized air bed allows both the forming of the electrostatic charges on the moving particles and the separation of said particles with a view to the sorting thereof.

The scraping means 280 of electrode 225 of the principal electrostatic sorting means 220 makes it possible to collect the particles attached to the electrode 225, the electric charge of which is strong, which means that the make-up thereof is particularly homogeneous.

The means 285 for cyclically reversing the polarity of each electrode 225 of the principal electrostatic sorting means 220 makes it possible to detach the particles attached to the electrodes 225, the make-ups of which are particularly homogeneous, and to collect the particles attached to each electrode without mechanical action such as scraping.

The particles attached to each electrode are detached and collected by virtue of the scraping or the reversing of polarity.

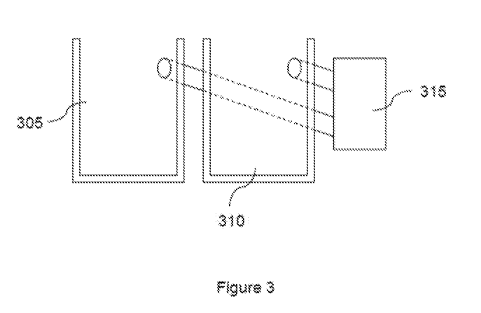

Two cyclonic separation units 305 and 310 connected to the same single suctioning means 315 are seen in FIG. 3. It is recalled that a cyclonic separation unit is a technological unit which applies a rapid rotation to a gas in order to separate therefrom, by centrifugation, the solid fine particles which are mixed therewith. The inlets of the cyclonic separation units 305 and 310 constitute, respectively, the containers 130 or 230, on the one hand, and 135 or 235, on the other hand.

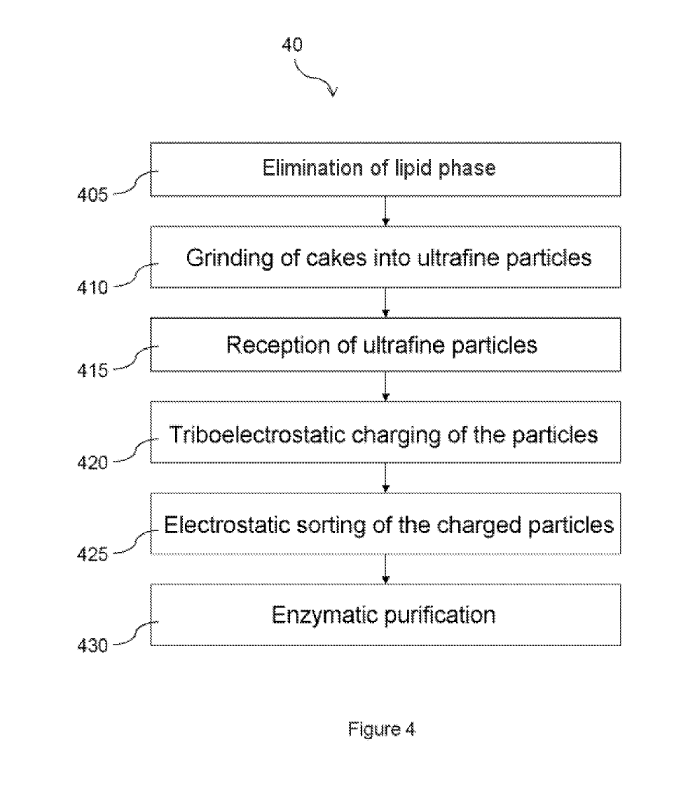

A particular flow diagram of steps of the process 40 which is the subject of the present invention is seen in FIG. 4. This process 40 comprises:
a step 405 of eliminating the lipid phase of the cakes,
a step 410 of grinding the cakes,
a step 415 of entry of ultrafine particles resulting from the grinding of oilseed cakes,
a step 420 of triboelectrostatically charging the particles received,
at least one step 425 of electrostatically sorting the charged particles so as to sort the particles into lignocellulose-enriched fractions, and
a step 430 of enzymatic purification.

The step 405 of eliminating the lipid phase of the cakes is preferentially carried out by a press configured for receiving cakes, pressing them and adding supercritical carbon dioxide thereto.

The step 410 of grinding the cakes thus treated is carried out with a grinder known per se, for example an impact grinder or a centrifugal grinder.

The step 415 of entry of ultrafine particles resulting from the grinding of oilseed cakes is carried out, for example, by using a hopper or a funnel configured for allowing the reception of ultrafine particles.

The triboelectrostatically charging step 420 is carried out, for example, by means of the collision between the particles received during the entry step 415 and an internal surface of a pipe comprising a part made of PVC, teflon and/or glass and steel, for example by using an air bed ventilated by virtue of a turbine or a fan for example. This air bed moves the particles so as to carry out the charging step 420 and to move these charged particles to an electrostatic sorting means.

Each electrostatic sorting step 425 is carried out, for example, by an electrostatic sorting means, comprising at least one electrode, configured for sorting the particles into lignocellulose-enriched fractions. In particular, the particles comprising lignocellulose-enriched fractions become positively charged during step 420. Consequently, these lignocellulose-enriched fractions are attracted by a negatively polarized electrode during the sorting step 425. The electrostatic sorting means also comprises a pipe close to the electrode and a pipe distant from the electrode, in such a way that the particles attracted by the electrode penetrate into the pipe in proximity to the electrode.

The step 430 of enzymatic purification is, for example, carried out by mixing the powdery fraction either with a solution containing a polysaccharide-hydrolyzing enzymatic cocktail or with water without the enzymes. After enzymatic hydrolysis and/or an extraction with water, the purified solid phase is separated by filtration or by centrifugation from the liquid phase which contains the sugars and molecules of interest resulting from the hydrolysis and/or from the extraction.

In order to carry out step 430, use is, for example, made of a stirred reactor in which the powdery fraction is mixed either with a solution containing a polysaccharide-hydrolyzing enzymatic cocktail, or with water without the enzymes. After enzymatic hydrolysis and/or an extraction with water, the purified solid phase is separated by filtration or by centrifugation from the liquid phase which contains the sugars resulting from the hydrolysis of the polysaccharides. In the degradation of the polysaccharides of the cakes by the enzymes, it is especially the cellulose which gives glucose. The hemicelluloses (in the cakes, these are xylans and arabinogalactans) give xylose and arabinose and galactose. This liquid phase, rich in monosaccharides such as glucose and xylose, can be used as a fermentation substrate for producing biofuels or biomolecules for green chemistry. On the other hand, the solid fractions are richer in proteins or in polyphenols, including lignin.

### EXAMPLE 1

### Fractionation of Sunflower Cake

An ultrafine powder was obtained by grinding in an impact grinder equipped with a 0.1 mm screen, and subjected to a fractions separation as set out with regard to FIGS. 1 to 4. In the results tables below:
F0 represents the initial sample,
F1B+ represents the fraction obtained on the positively charged electrode when a single stage is implemented,
F1A− represents the fraction obtained on the negatively charged electrode when a single stage is implemented,
F2BB+ represents the fraction obtained on the positively charged electrode when, at the inlet of a second stage, the sample is the F1B+ fraction, and
F2AA− represents the fraction obtained on the negatively charged electrode when, at the inlet of a second stage, the sample is the F1A− fraction.

Table 1 gives the composition, as percentage of dry weight, of the fractions resulting from sunflower cakes after grinding with a centrifugal grinder equipped with a 0.25 mm screen and separation according to the process which is the subject of the present invention (the electrodes have a potential difference of 15 KVolts, are at a distance from one another of 3 cm, and are 30 cm high and 10 cm wide):

| Substrate | Fraction | Proteins | Ash | Lignin |
|---|---|---|---|---|
| Sunflower | F0 | 30.4 | 6.2 | 21.2 |
| | F1B+ | 46.7 | 7.4 | 6.7 |
| | F1A− | 10.6 | 5.2 | 28.1 |
| | F2BB+ | 58.8 | 8.6 | 1.1 |
| | F2AA− | 10.2 | 4.2 | 42.2 |

Table 2 gives details of the protein, lignin and phenolic acid contents, in the case of an impact grinder regulated at 0.1 mm:

| | Composition (mg/g) | | | | | |
|---|---|---|---|---|---|---|
| | Pro- | Phenolic acids | | | | |
| Fractions | teins | FA⁽¹⁾ | p-CA⁽²⁾ | di-FA⁽³⁾ | Vanillic Ac⁽⁴⁾ | Lignin |
| F0 | 30.80 | 0.068 | 0.028 | 0.019 | 0.049 | 21.2 |
| F1B+ | 57.43 | 0.044 | 0.026 | 0.003 | 0.011 | 7.5 |
| F1A− | 5.10 | 0.087 | 0.034 | 0.040 | 0.100 | 39.4 |
| F2BB+ | 55.67 | 0.042 | 0.025 | 0.003 | 0.012 | 4.2 |
| F2AA− | 6.99 | 0.094 | 0.034 | 0.039 | 0.098 | 40.8 |

⁽¹⁾“FA” is the acronym for “ferulic acid”, which has antioxidant properties (food and non-food use).
⁽²⁾“p-CA” is the acronym for “p-coumaric acid”, which has antioxidant properties (food and non-food use).
⁽³⁾“di-FA” is the acronym for “dimer FA”, a chemical intermediate for polymer synthesis.
⁽⁴⁾“Vanillic Ac” is the abbreviation for vanillic acid.

The method for assaying the lignins is, for example, the Klason method discussed in the publication Barakat et al. 2014 Applied Energy, 113, 97-105.

Phenolic acids are small molecules linked both to polysaccharides (xylan) and to lignin via ester and ether bonds. These phenolic acids can be fractionation and separation indicators. Phenolic acids also have advantageous functional properties, in particular antioxidant properties.

FIG. 5 represents the phenolic acids composition for the sunflower from table 2. For each fraction, the bar furthest to the left, 505, represents the ferulic acid content, the next one to the right, 510, the p-coumaric acid, then the dimer ferulic acid, bar 515, and, finally, the vanillic acid, bar 520.

As is understood in the light of table 1 and FIG. 5, the implementation of the present invention makes it possible, as early as the first separation step, to separate, on the one hand, a fraction rich in lignin, in p-coumaric acid, in dimer FA and in vanillic acid, and, on the other hand, a fraction rich in proteins.

It is also noted, in this table 1, that the second step of electrostatic sorting substantially increases the enrichment, in particular for lignin, for which the ratio of contents goes from 28.1 (F1A− fraction), after the first separation step, to 42.2 (F2AA− fraction) after the second.

After analysis, it is noted that the F2BB+ fraction is very rich in molecules of interest. For this fraction, a simple extraction with water is sufficient to extract molecules of interest and to further concentrate the solid fraction in terms of protein. It is noted, however, that the addition of enzyme has an effect on the molecule extraction yield, which is almost doubled (see Barakat et al., Applied Energy 2013, 113 (2014) 97-105, which gives details of the methods used here for analyzing the sugars, the lignin and the enzymatic degradation part mentioned later).

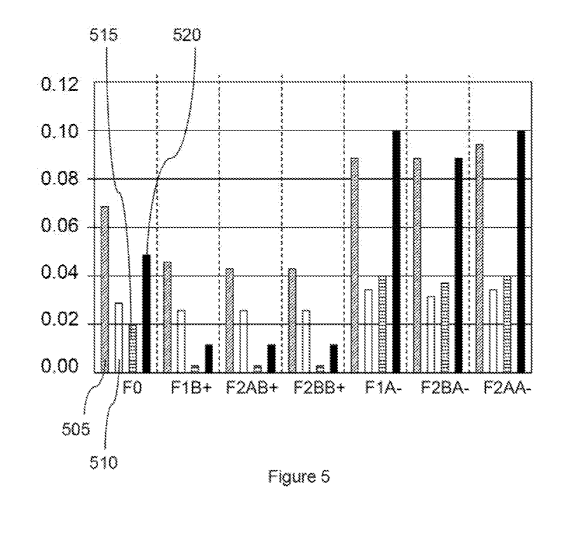

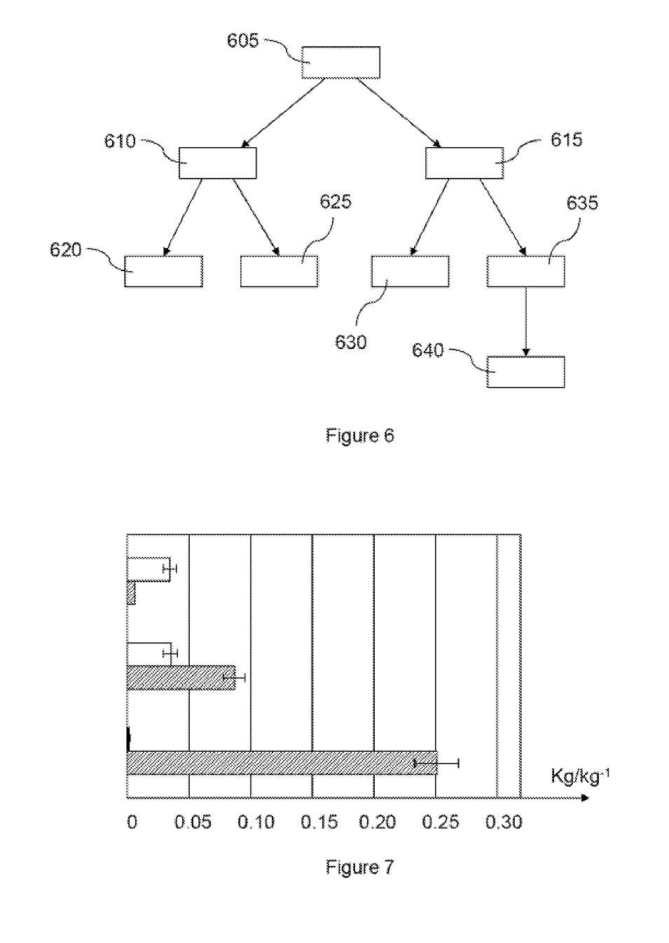

For its part, the F2AA− fraction is very rich in sugars (glucose and xylose) and less rich in molecules of interest compared with the F2BB+ fractions. For this fraction, an extraction is of use for extracting sugars and further concentrating the solid fraction in lignin (see FIG. 6).

Table 3 below represents the enrichment with cellulose and hemicelluloses, from which it is possible to generate bioethanol (cellulose) or biogas (cellulose and hemicellulose) after grinding with an impact grinder (Hozokawa Alpine, registered trademark) with a screen of 0.1 mm. The electrodes have a potential difference of 15 KVolts, are at a distance from one another of 3 cm and are 30 cm high and 10 cm wide.

| | | Hemicelluloses | | | | | |
|---|---|---|---|---|---|---|---|
| Fractions | Cellulose | Xyl | Ara | Gal | Ac Glc | Ac Gal | Total |
| F0 | 17.61 | 9.53 | 1.32 | 0.11 | 2.23 | 0.40 | 13.60 |
| F1B+ | 7.79 | 4.42 | 1.06 | 0.35 | 1.93 | 0.03 | 7.79 |
| F1A− | 23.00 | 12.35 | 1.29 | 0.02 | 3.05 | 0.46 | 17.17 |
| F2BB+ | 7.82 | 4.87 | 1.21 | 0.38 | 1.99 | 0.04 | 8.49 |
| F2AA− | 24.02 | 13.75 | 1.59 | 0.03 | 3.24 | 0.76 | 19.37 |

The Ara/Xyl, Gal/Xyl and UA ratios then emerge as given in table 4 below:

| | Ara/Xyl | Gal/Xyl | UA |
|---|---|---|---|
| F0 | 0.138 | 0.012 | 2.63 |
| F1B+ | 0.239 | 0.079 | 1.96 |
| F1A− | 0.104 | 0.002 | 3.51 |
| F2BB+ | 0.248 | 0.078 | 2.03 |
| F2AA− | 0.116 | 0.002 | 4.00 |

In this table:
“Ara” means arabinose
“Xyl” means xylose
“Gal” means galactose
“UA” means uronic acid.

The Ara/Xyl and Gal/Xyl ratios and the uronic acid UA content give an indication regarding the structure of the polymers or polysaccharides. These ratios and also the UAs can be an indicator of fractionation and separation. Moreover, the uronic acids are often linked to lignin and to polysaccharides. These molecules have many applications in green chemistry.

Once again, the effectiveness of implementing the present invention is noted.

In order to estimate the advantage of the enzymatic purification, 2 g of each fraction were dissolved in 20 mL of water with or without commercial enzyme (20 U/g of substrate) with stirring for 72 hours at 37° C. The two liquid and solid fractions were separated by centrifugation.

### EXAMPLE 2

### Fractionation of Rapeseed Cake

With regard to the composition, as percentage of dry weight, of the cake fractions after grinding on a centrifugal grinder with a 0.25 mm screen (the electrodes have a potential difference of 15 KVolts, are at a distance from one another of 3 cm and are 30 cm high and 10 cm wide):

| Substrate | Fraction | Proteins | Ash | Lignin |
|---|---|---|---|---|
| Rapeseed | F0 | 38.5 | 5.6 | 14.6 |
| | F1B+ | 47.6 | 6.2 | 9.6 |
| | F1A− | 27.6 | 4.4 | 24.7 |
| | F2BB+ | 57.9 | 6.8 | 7.6 |
| | F2AA− | 18.4 | 4.2 | 35.4 |

After analysis, it is noted that the F1B+ fraction, and even more so the F2BB+ fraction, are enriched with proteins and ash and depleted of lignin, compared with the initial sample. For these fractions, a simple extraction with water is sufficient to extract proteins and to thus further concentrate the solid fraction in protein. It is noted, however, that the addition of enzyme has an effect on the molecule extraction yield, which is almost doubled.

For its part, the F1A− fraction, and even more so the F2AA− fraction, are enriched with lignin, and depleted of proteins and ash, compared with the initial sample. For these fractions, an extraction is of use for extracting sugars and thus further concentrating the solid fraction in lignin.

Regarding the non-denaturation of the lignins, the lignocellulose obtained by implementing the present invention is in the native state, i.e. it is not modified or denatured, contrary to the prior art processes.

In support of this assertion, the lignin fractions were characterized in terms of β-O-4 bonds in μmol·g⁻¹ and of S/G ratio (S: syringyl unit and G: guaiacyl unit, two constituent monomers of lignin) in the initial fraction and the lignin-enriched fractions (F−). The β-O-4 bonds are inter-lignin-polymer ether bonds; they are the most abundant bonds in native lignin (see “Dry fractionation process as an important step in current and future lignocellulose biorefineries: A review” A Barakat, H de Vries, X Rouau. Bioresource technology 134, 362-373, incorporated herein by way of reference).

The results clearly show that these two parameters, which are very characteristic of lignin modification during extraction processes, are not modified by the electrostatic process:
685 μmol·g⁻¹ with an S/G ratio=0.38 for the initial fraction (F0) and
689 μmol·g⁻¹ with an S/G ratio=0.38 for the negatively charged fraction (F−).

An embodiment of the enrichment process comprising a dry fractionation by electrostatic separation, followed by a step of enzymatic treatment of the fractions obtained, is described with regard to FIGS. 6 and 7. As set out with regard to FIG. 5, the F1A− fraction, and even more so the F2AA− fraction, are enriched with lignin, and depleted of proteins and ash, compared with the initial sample. For these fractions, an extraction is of use to extract sugars and to thus further concentrate the solid fraction in lignin. With regard to FIG. 6, details are given of an enzymatic purification and/or extraction (cellulase and hemicellulases) for further enriching the fractions with proteins and with polyphenols (lignin and phenolic acids) by degradation or hydrolysis of the polysaccharides to monosaccharides (glucose, xylose, arabinose, etc.).

FIG. 6 represents the mechanical and enzymatic fractionation of the cakes.

Starting from an F0 sample 605, the electrostatic separation provides an F2BB+ fraction 610 and an F2AA− fraction 615. These fractions are hydrolyzed by a commercial enzymatic cocktail (cellulase+xylanase) (Sigma, registered trademark) in liquid medium at 10% w/v (weight by volume), pH 5 at 37° C. for 72 hours. After the end of the reaction, the solutions were centrifuged or filtered, and two solid and liquid fractions were obtained:

the solid fraction 620, rich in proteins (72% w/w), is derived from the F2BB+ fraction 610,

the liquid fraction 625, rich in soluble sugars and proteins, is derived from the F2BB+ fraction 610,

the solid fraction 630, rich in lignin, is derived from the F2AA− fraction 615 and

the liquid fraction 635, rich in soluble sugars, is derived from the F2AA− fraction 615.

The liquid fractions 625 and 635 were characterized in terms of soluble sugars and the solid fractions 620 and 630 were characterized in terms of lignins and proteins.

In FIG. 7:
the white rectangles represent the proportions, by weight, in the liquid fraction 625 derived from the F2BB+ fraction 610,
the hatched rectangles represent the proportions, by weight, in the liquid fraction 635 derived from the F2AA− fraction 615,
the two uppermost rectangles represent the proportions, by weight, of arabinose,
the following two rectangles represent the proportions, by weight, of xylose and
the two lowermost rectangles represent the proportions, by weight, of glucose.

It is observed in FIG. 7 that the fiber-rich F2AA− fraction 615 produces more glucose (C6), in a proportion of 0.25 kg·kg⁻¹, 0.087 kg·kg⁻¹ of xylose (C5) and 0.0064 kg·kg⁻¹ of arabinose (C5), in a proportion of 0.09 kg·kg⁻¹.

On the other hand, the F2BB+ fraction 610 produces virtually no glucose (approximately 0.002 kg·kg⁻¹), 0.032 kg·kg⁻¹ of xylose (C5) and 0.035 kg·kg⁻¹ of arabinose (C5), this fraction being rich in soluble proteins (and other molecules of interest).

These results show that the fiber-enriched fractions (F−) produce more fermentable sugars compared with the protein-enriched fractions (F+).

In conclusion, the fractions (F−) can be exploited, by fermentation, in bioenergy in the form of ethanol 640. Indeed, the sugars derived from the F2AA− fraction after enzymatic hydrolysis are fermented by yeasts so as to produce ethanol according to the method described by Barakat et al. 2015 (“Innovative combined dry fractionation technologies for rice straw valorization to biofuels” S Chuetor, R Luque, C Barron, A Solhy, X Rouau, A Barakat. Green Chemistry, 2015 DOI: 10.1039/C4GC01718H, incorporated herein by way of reference). The yield of ethanol produced after a fermentation of 72 hours is of the order of 0.1035 kg·kg⁻¹ obtained with the negatively charged fraction (F2A−).

The solid fractions (scheme 1) were also characterized. The results clearly show that this enzymatic hydrolysis step made it possible to further enrich the positively charged fractions with proteins (72% w/w) and the negatively charged fractions with lignin (65% w/w).

1-15. (canceled)

16. A dry process for the fractionation of oilseed cakes, comprising the steps of:
grinding oilseed cakes into a powder of ultrafine particles;
triboelectrostatically charging the ultrafine particles of said powder; and
deviating a path of charged ultrafine particles in an electric field to sort the ultrafine particles and to provide at least one lignocellulose-enriched fraction.

17. The process as claimed in claim 16, wherein the grinding step comprises the step of configuring a grinder to obtain a predetermined fineness.

18. The process as claimed in claim 16, further comprising the step of scraping an electrode of an electrostatic sorter used during the deviating step to collect the ultrafine particles attached to the electrode after the deviating step.

19. The process as claimed in claim 16, further comprising the step of cyclically reversing a polarity of each electrode of an electrostatic sorters used during the deviating step.

20. The process as claimed in claim 16, further comprising, downstream of the deviating step, at least one secondary deviating step.

21. The process as claimed in claim 20, wherein, during said at least one secondary deviating step, a triboelectrostatically charger is fed with the ultrafine particles which, during the deviating steps, are alternately deviated toward a positive electrode and a negative electrode or vice versa.

22. The process as claimed in claim 16, further comprising, downstream of the deviating step, the step of enzymatically purifying the sorted particles.

23. The process as claimed in claim 16, further comprising, downstream of the deviating step, the steps of comparing sizes of the ultrafine particles with regard to a predetermined limit value; and feeding a grinder with the ultrafine particles of which the sizes are greater than the predetermined limit value.

24. The process as claimed in claim 16, wherein a dynamic fluidized air bed is used during the triboelectrostatically charging step.

25. A method of obtaining lignocellulose-enriched fractions using the process as claimed in claim 16.

26. A method of obtaining protein-enriched fractions using the process as claimed in claim 16.

27. A method of generating biofuel from lignocellulose-enriched fractions using the process as claimed in claim 16.

28. A method of generating biogas from lignocellulose-enriched fractions using the process as claimed in claim 16.

29. A method of obtaining polysaccharide-enriched fractions using the process as claimed in claim 16.

30. A method of extracting and obtaining phenolic-derivative-enriched fractions using the process as claimed in claim 16.
